(19) United States
(12) Patent Application Publication
(10) Pub. No.: US 2026/0054946 A1
(43) Pub. Date: Feb. 26, 2026

(54) MANUAL HOOK VEHICLE RESTRAINT SYSTEM

(71) Applicant: Multi-Fab Products, LLC, Menomonee Falls, WI (US)

(72) Inventors: Thomas J. Palus, Mequon, WI (US); Sunil Kalavathi, Sheboygan, WI (US)

(73) Assignee: Multi-Fab Products, LLC, Menomonee Falls, WI (US)

(21) Appl. No.: 18/809,919

(22) Filed: Aug. 20, 2024

(51) Int. Cl. B65G 69/00

(52) U.S. Cl. CPC B65G 69/003

(57) ABSTRACT

The manual vehicle restraint system utilizes a hook mounted to a main shaft to immobilize a vehicle. The hook and the main shaft rotate around a common axis, biased to rotate by a spring. A latch assembly operably connected to the main shaft may be manually actuated to allow rotation of the main shaft and hook to raise the hook and capture a vehicle. Raising of the hook does not require a power source other than the spring.

### BACKGROUND

This invention relates to a vehicle restraint system, specifically a manually-actuated hook system capable of restraining a vehicle trailer during loading and unloading.

If a vehicle trailer is removed prematurely from a loading dock, the trailer may still contain workers or a fork truck and operator. Worse, the trailer may be removed when the workers or fork truck are transitioning from the loading dock to the trailer. Either action can cause workers or the fork truck and operator to fall from the trailer or impact a trailer wall, resulting in significant injury to persons and damage to property. To prevent premature removal, a vehicle restraint on the loading dock is moved into an operable position by the trailer backing up to the loading dock and contacting the restraint. Once the trailer is in position, a loading dock attendant engages the restraint which in turn rotates a vehicle restraining hook in the restraint such that the hook engages the rear impact guard bar, or RIG bar, of the trailer. Once engaged, the hook prevents the RIG bar and therefore the trailer from being removed from the loading dock until properly released by the dock attendant.

The hook still allows for some limited horizontal motion of the RIG bar and trailer in the engaged position. It is not until the RIG bar is moved sufficiently away from the loading dock that the hook captures the RIG bar and prevents further horizontal motion. This horizontal motion can occur for a number of reasons including the momentum transfer of the fork truck stopping and starting in the trailer or entering or exiting the trailer, especially if the brakes of the trailer have not been properly set, or the truck driver driving away prematurely. After the RIG bar is captured, horizontal movement of the trailer may move the hook to its furthest point away from the loading dock, with the RIG bar gaining contact with the hook at one point on the upper portion of the RIG bar and one point on the lower portion of the RIG bar. In this position, the hook has been pulled and rotated by the RIG bar into the most forward and lowest position in which the hook can reliably capture the RIG bar. The RIG bar may have an attached plate which prevents the hook from finding proper purchase around the RIG bar. In this case, only the tip of the hook may make contact. As a result, horizontal movement of the trailer may force the hook to move downwards and out of contact with the RIG bar, resulting in the hazardous conditions that the hook system was intended to prevent.

The hook used in these restraints is often operated via electromechanical means, usually an electric motor coupled to a shaft rotational speed reducer such as a gear-based drivetrain and/or sprockets and chain. These electromechanical systems are reliant on power sources to move the hook, requiring a more complex installation process and becoming unusable if the power supply is interrupted.

There is an unmet need in the art for a manually operated rotating hook-based vehicle restraining system capable of reducing the effects of forced hook rotation in the disengaging direction.

### BRIEF SUMMARY OF THE INVENTION

An embodiment of a manual vehicle restraining hook system includes a hook mounted to a main shaft such that the hook and the main shaft rotate around a common axis. A main spring is operably connected to the main shaft. The main spring is capable of rotating the main shaft and hook. A latch assembly is operably connected to the main shaft, such that actuation of the latch assembly to a first configuration prevents rotation of the main shaft and hook, and actuation of the latch assembly to a second configuration allows rotation of the main shaft and hook.

### BRIEF DESCRIPTION OF THE DRAWINGS

FIG. 1 shows a perspective view of a first exemplary embodiment of a manual hook vehicle restraint system with the hook raised.

FIG. 2 shows a perspective view of the first exemplary embodiment of the manual hook vehicle restraint system with the hook lowered.

FIG. 3 shows a side view of the first exemplary embodiment of the manual hook sub-assembly with the hook raised.

FIG. 4 shows a side perspective view of the first exemplary embodiment of the manual hook sub-assembly with the hook lowered.

FIG. 5 shows a side perspective view of the first exemplary embodiment of the manual hook sub-assembly with the hook raised.

FIG. 6 shows a side view of the first exemplary embodiment of the manual hook sub-assembly with the hook raised prior to engaging with a RIG bar.

FIG. 7 shows a side perspective view of the first exemplary embodiment of the manual hook sub-assembly with the hook raised.

FIG. 8 shows a side view of the first exemplary embodiment of the manual hook sub-assembly with the hook raised prior to engaging with the RIG bar.

### DETAILED DESCRIPTION

In the present description, certain terms have been used for brevity, clearness and understanding. No unnecessary limitations are to be applied therefrom beyond the requirement of the prior art because such terms are used for descriptive purposes only and are intended to be broadly construed. The different systems and methods described herein may be used alone or in combination with other systems and methods. Various equivalents, alternatives and modifications are possible within the scope of the appended claims. Each limitation in the appended claims is intended to invoke interpretation under 35 U.S.C. §112, sixth paragraph, only if the terms “means for” or “step for” are explicitly recited in the respective limitation.

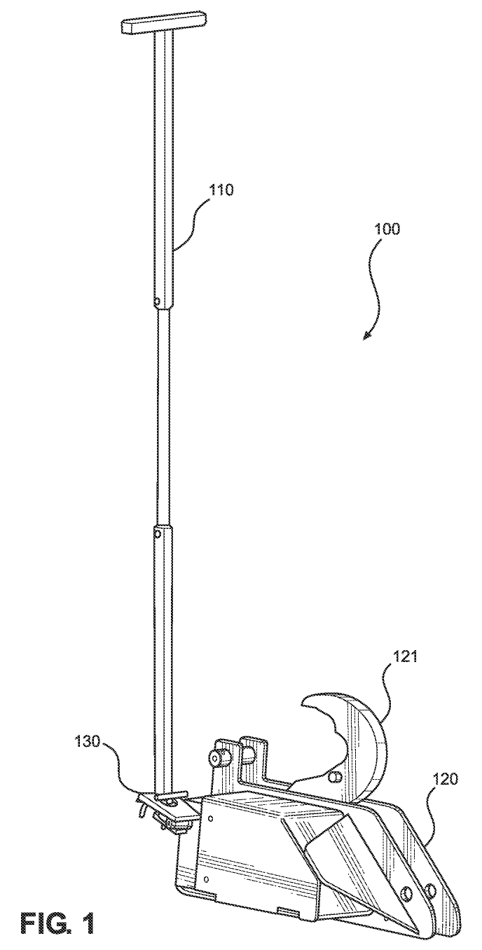

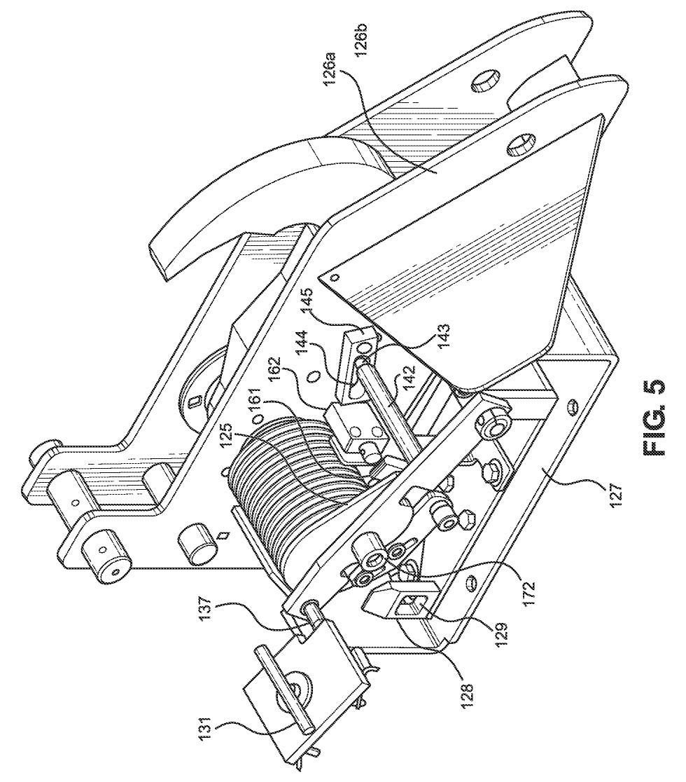

As shown in FIGS. 1-3, the hook assembly 120 used in the vehicle restraint system 100 includes a hook 121 fixedly mounted to a main shaft 123. The hook 121 and main shaft 123 rotate together around a common axis. The hook 121 may be keyed to ensure rotation with the main shaft 123. The hook 121 is located between a carriage comprised of a left carriage plate 126a and a right carriage plate 126b as shown in FIG. 5. It should be appreciated that while the present embodiment makes reference to additional components of the system 100 in relation to their position with regard to the left carriage plate 126a, such components may also be mounted to the right carriage plate 126b in a mirrored orientation.

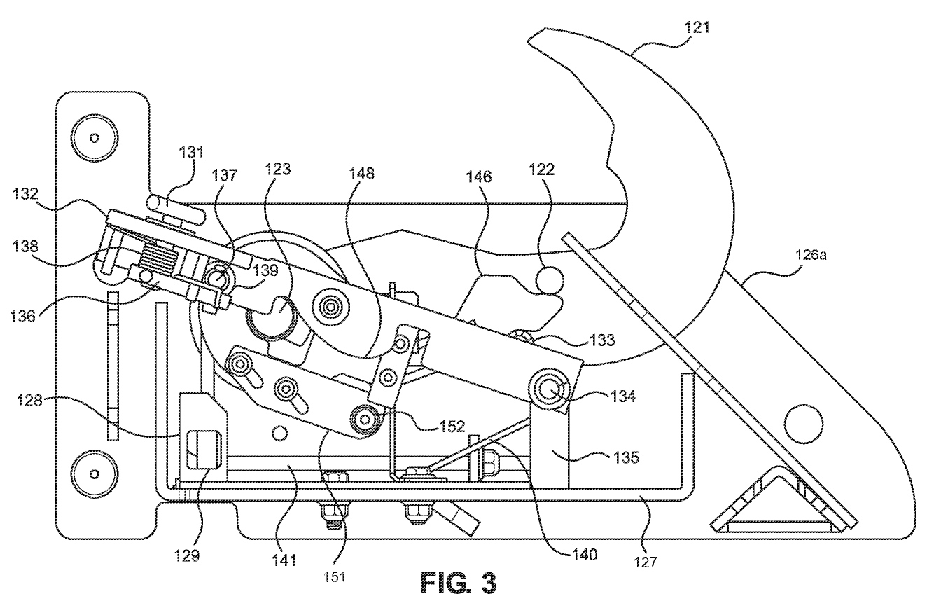

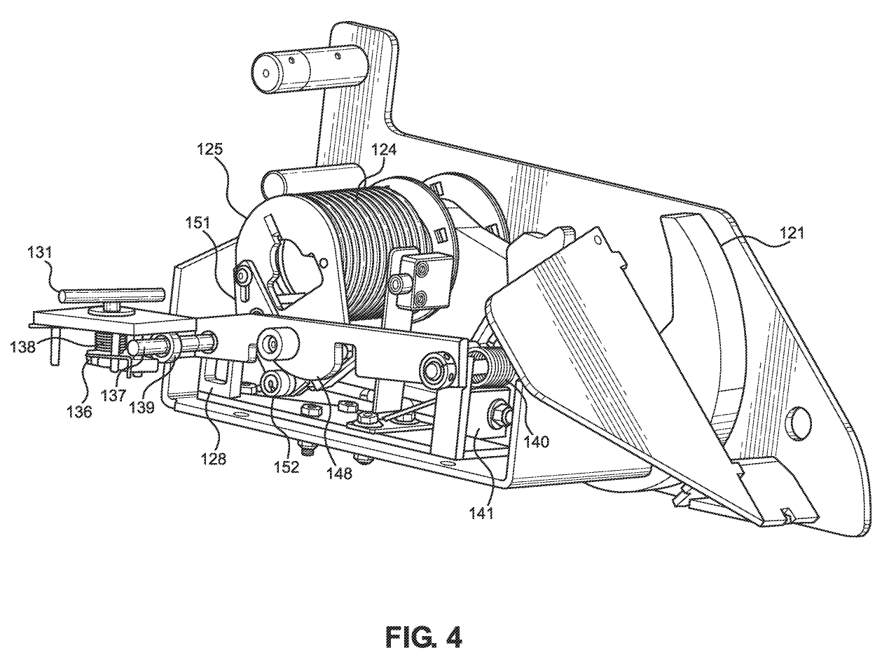

As shown in FIGS. 3-5, left carriage plate 126a has an integral or connected base plate 127 extending perpendicularly away from the left carriage plate 126a. The main shaft 123 extends through the left carriage plate 126a and parallel to the base plate 127. A main spring 124 provides biasing of the main shaft 123 to raise the hook 121 by rotating the hook 121 in a counterclockwise direction as seen from the left side of the hook assembly 120 in FIGS. 4 and 5. In one embodiment, the main spring 124 is a torsion spring mounted around the main shaft 123. A spring end plate 125 is keyed to the main shaft 123 to orient and maintain the connection of main spring 124 to main shaft 123. The main spring 124 is located between the left carriage plate 126a and spring end plate 125. In certain embodiments, a spring adjustment 141 is used to compensate for potential weakening of the main spring 124 over time. The spring adjustment 141 is attached to one end of main spring 124 to allow an increased initial reload of the main spring 124 without any disassembly.

A latch assembly 130 is utilized to prevent the hook 121 from freely rotating in the hook assembly 120. The latch assembly 130 shown in FIGS. 3-5 comprises a latch release 131 slidably and rotatably extending through an aperture in a latch plate 132 where the latch release 131 is fixed to a latch linkage 136. The latch linkage 136 is rotatably connected to a latch pin 137 extending out from under the latch plate 132. A latch pin spring 138 extending between the latch plate 132 and latch linkage 136 biases the latch pin 137 to an extended position. In one embodiment, the latch pin spring 138 is a torsion spring. In one embodiment, an annular or partially annular pin support 139 extending from a bottom surface of latch plate 132 at least partially encircles and provides support to the latch pin 137 slidably extending therethrough.

Rotation of the latch release 131 against the bias of the latch pin spring 138 will rotate the latch linkage 136 and cause the latch pin 137 to retract at least partially under the latch plate 132. This will cause the latch pin 137 to disengage from a pin aperture 129 in a pin receiver 128 extending from the base plate 127, thereby allowing latch assembly 130 to move upwards relative to the base plate 127 and the remainder of the hook assembly 120. The pin receiver 128 may have a chamfered upper surface above the pin aperture 129, such that when the latch assembly 130 moves downwards, movement of the latch pin 137 along the chamfered surface causes the latch pin 137 to be retracted under the latch plate 132 against the bias of the latch pin spring 138. This allows the latch pin 137 to be reengaged with the pin aperture 129 merely by applying a downward force to the latch assembly 130, rather than the more complex motion of rotating the latch release 131 while applying a downward force.

The latch plate 132 extends from a latch arm 133. The latch arm 133 is rotatably connected to and supported a latch arm shaft support 135 extending from the base plate 127. A latch arm shaft 134 rotatably interconnects the latch arm 133 and latch arm shaft support 135. A latch arm spring 140 connected to the latch arm 133 biases the latch assembly 130 to rotate upwards relative to the base plate 127. In one embodiment, the latch arm spring 140 is a torsion spring mounted around the latch arm shaft 134, as shown in FIG. 4.

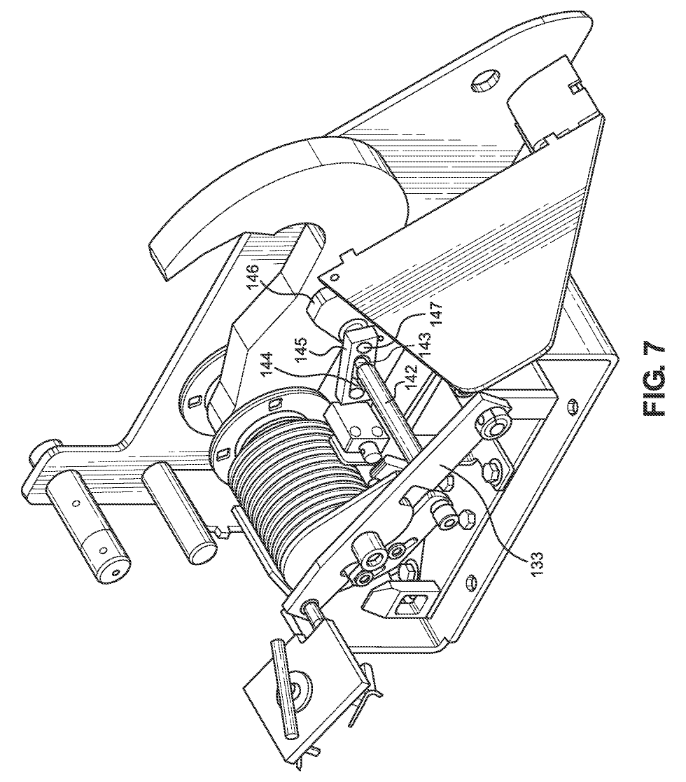

As shown in FIGS. 5-8, the latch arm 133 also provides an additional safety feature preventing the hook 121 from lowering if the hook 121 fails to fully capture a RIG bar, such as if the RIG bar is not a standard configuration or has a flat plate in front of it. An arm pin 142 extends between the latch arm 133 and left carriage plate 126a, being connected or integral to a surface of the latch arm 133. An arm pin follower 143 is located on the free end of arm pin 142 proximal to the left carriage plate 126a. The arm pin follower 143 travels in a cam slot 144 extending through a follower bracket 145 rotatably mounted to one side of the left carriage plate 126a by a pivot catch shaft 147. The pivot catch shaft 147 extends through the left carriage plate 126a to rotatably mount a pivot catch 146 to the other side of the left carriage plate 126a, between the left and right carriage plate 126a and 126b. The movement of the arm pin follower 143 in the cam slot 144 of the rotating follower bracket 145 converts the relative motion of the latch assembly 130 into a simple rotating motion of the pivot catch 146 due to the pivot catch shaft 147 fixedly interconnecting the follower bracket 145 and the pivot catch 146 through the left carriage plate 126a.

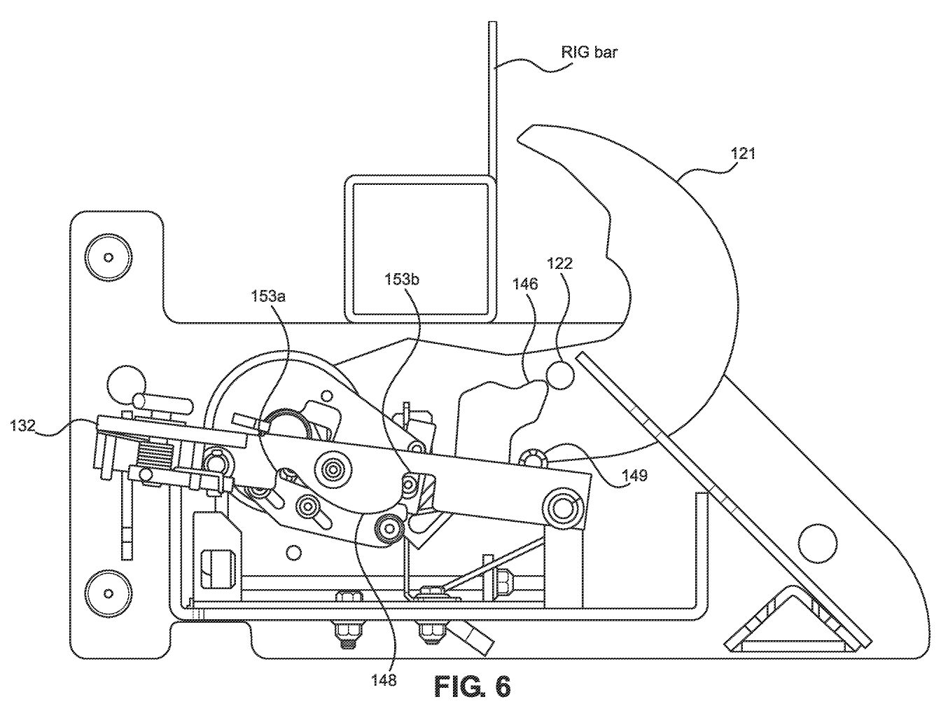

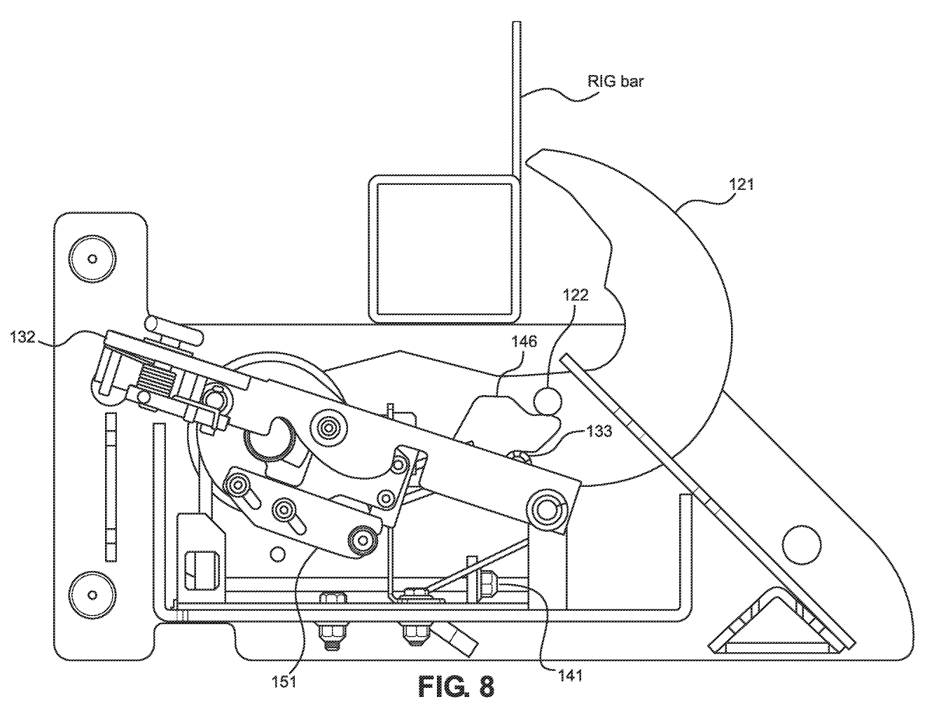

The pivot catch 146 is configured to interact with at least one hook tab 122 extending laterally from at least one side of the hook 121 and at least one pivot catch stop 149 extending laterally from the left carriage plate 126a. In a first rotational position, shown in FIG. 8, the pivot catch 146 is stopped from rotation against the pivot catch stop 149. The pivot catch then 146 prevents the hook 121 from lowering by catching the hook tab 122 and stopping movement of the hook 121. This provides an additional safety feature if the hook 121 fails to fully capture a RIG bar, such as if the RIG bar is not a standard configuration or has a flat plate in front of it. Because the hook 121 cannot rotate downwards below the upper edges of left and right carriage plates 126a and 126b, being prevented by the combination of the pivot catch 146 and pivot catch stop 149, the raised hook 121 still blocks forward movement of the RIG bar and therefore the vehicle. In a second rotational position, shown in FIG. 6, the irregular shape of pivot catch 146 is not rotationally positioned to contact the hook tab 122 and allows the hook 121 to lower, as pivot catch stop 149 is positioned on the left carriage plate 126a to avoid contacting the hook tab 122. When latch arm spring 140 biases potions of the latch assembly 130 upwards, the interlinked movement of the latch arm 133, arm pin 142, arm pin follower 143, and follower bracket 145 moves pivot catch 146 to the second rotational position. When the latch assembly 130 is pushed downwards, the interlinked movement of the latch arm 133, arm pin 142, arm pin follower 143, and follower bracket 145 moves pivot catch 146 to the first rotational position, out of the way of the hook tab 122.

An adjustment bracket 151 maintains the upper and lower limit of the hook 121 rotation for proper operation of the vehicle restraint system 100. The adjustment bracket 151 is mounted to the spring end plate 125, rotating with the rotation of the spring end plate 125. A free end of the adjustment bracket 151 comprises a cam roller 152 which interacts with an arm cam surface 148 as the latch arm 133 moves upwards and downwards. The arm cam surface 148 extends along a lower surface of the latch arm 133. The arm cam surface 148 provides a first stop 153a at a first end of the arm cam surface 148 and a second stop 153b at a second end of the arm cam surface 148. The first and second stops 153a and 153b prevent the cam roller 152 from proceeding along the latch arm 133 as the latch arm 133 moves upward and downwards, respectively. Fixation of the adjustment bracket 151 to the spring end plate 125 is adjustable, as shown in FIG. 3. Since alignment between the cam roller 152 and arm cam surface 148 can be adjusted to compensate for cumulative production and assembly tolerances, proper interaction between the cam roller 152 and arm cam surface 148 is ensured.

Certain embodiments may include a switch sensor 162, as shown in FIG. 5. At least one switch trigger 161 may be attached to spring end plate 125 at various points to trigger the switch sensor 162 at various rotational positions of the hook 121. In certain embodiments, when the hook 121 is in proper hooking range, the switch trigger 161 contacts a switch sensor 162 to actuate at least one indicator signal (not shown) to signal a driver not to move the vehicle and/or to signal a system operator that the vehicle restraint system 100 is properly securing the vehicle. After visually verifying that the RIG bar is restrained by the hook, the operator then can unload/load the vehicle. In certain embodiments, when the hook 121 is not in proper hooking range, the switch trigger 161 contacts the switch sensor 162 to actuate at least one indicator signal (not shown) to signal a driver that it is safe to move the vehicle or to signal a system operator that the vehicle restraint system 100 is not properly securing the vehicle. Such an indicator signal may take the form of: flashing or illuminated colored lights, flashing or illuminated indicia, an audible signal, or any combination thereof.

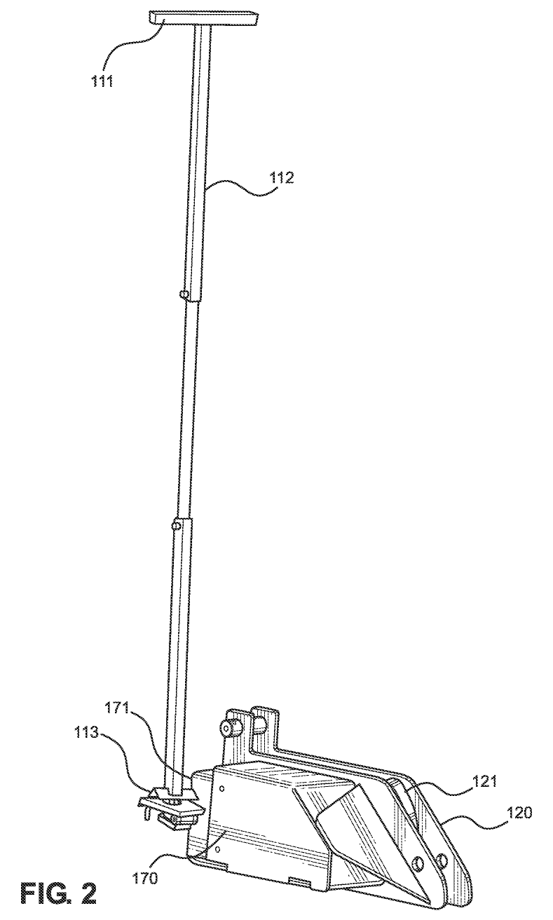

As shown in FIGS. 1 and 2, a housing 170 covers most of the latch assembly 130 and seals out debris from entering into the linkage area of the latch assembly 130. In certain embodiments, a brush seal 171 extends through the housing 170 to allow the latch assembly 130 to freely travel up and down. In certain embodiments, as shown in FIG. 5, a wear resistant guide 172 attached to the latch arm 133 slides against inside of the housing 170 to guide the latch arm 133 in an up and down motion instead of moving side to side during actuation.

As shown in FIGS. 1 and 2, the latch release 131 is configured to interact with a separate release actuator 110. The release actuator 110 has a handle 111 and a release interface 113, with a shaft 112 extending therebetween. In certain embodiments, the shaft 112 has an adjustable length. The release interface 113 removably interlocks with the latch release 131, allowing the latch release 131 to be remotely manipulated. In the embodiments shown in FIGS. 4 and 6, the latch release 131 is a T-shaped element, with the T crossbar interacting with a release interface 113 having an inverted V-shaped cross-section. In other embodiments, the release interface 113 may have an inverted U-shaped cross-section.

In order to actuate the latch assembly 130, a user pushes down with the release actuator 110 on the latch release 131 to relieve the bias of the latch pin spring 138 and then rotates the release actuator 110 to moves the latch pin 137 out of the pin receiver 128. The user then removes the release actuator 110 which allows the hook 121 to rotate and rise due to the bias of the main spring 124, thereby capturing a RIG bar. To release the vehicle, the user pushes down with release actuator 110 on catch latch release 131 until the latch pin 137 engages the pin receiver 128. This pushes down the latch arm 133, causing the cam roller 152 to roll along the arm cam surface 148, rotating the interconnected adjustment bracket 151, attached spring end plate 125, and the main shaft 123 and attached hook 121.

In the foregoing description, certain terms have been used for brevity, clearness, and understanding. No unnecessary limitations are to be inferred therefrom beyond the requirement of the prior art because such terms are used for descriptive purposes and are intended to be broadly construed. The different configurations, systems, and/or method steps described herein may be used alone or in combination with other configurations, systems and/or method steps. It is to be expected that various equivalents, alternatives and/or modifications are possible within the scope of the appended claims.

What is claimed is:

1. A manual vehicle restraining hook system, comprising:
a hook mounted to a main shaft such that the hook and the main shaft rotate around a common axis;
a main spring operably connected to the main shaft, wherein the main spring is configured to rotate the main shaft and hook; and
a latch assembly operably connected to the main shaft, wherein actuation of the latch assembly to a first configuration prevents rotation of the main shaft and hook, wherein actuation of the latch assembly to a second configuration allows rotation of the main shaft and hook.

2. The system of claim 1, wherein the latch assembly comprises:
a latch release slidably and rotatably extending through an aperture in a latch plate;
a latch linkage fixedly connected to the latch release;
a latch pin rotatably connected to latch linkage and extending out from under the latch plate; and
a latch pin spring extending between the latch plate and the latch linkage, wherein the latch pin spring biases the latch pin to an extended position.

3. The system of claim 2, further comprising a pin receiver extending from a base plate, wherein the pin receiver comprises a pin aperture, wherein the latch pin extends through the pin aperture in the first configuration of the latch assembly.

4. The system of claim 3, wherein the pin receiver comprises a chamfered upper surface above the pin aperture.

5. The system of claim 2, wherein the latch assembly further comprises:
a latch arm rotatably connected to and supported by a latch arm shaft support extending from a base plate;
a latch arm shaft rotatably interconnecting the latch arm and latch arm shaft support; and
a latch arm spring connected to the latch arm and biasing the latch assembly to rotate upwards relative to the base plate.

6. The system of claim 5, wherein the latch arm spring is a torsion spring.

7. The system of claim 5, wherein the latch assembly further comprises:
an arm pin extending from the latch arm toward a carriage plate;
an arm pin follower on a free end of the arm pin proximal to the carriage plate;
a follower bracket rotatably mounted to a first side of the carriage plate by a pivot catch shaft, wherein a cam slot extends through the follower bracket, wherein the arm pin follower travels along the cam slot;
a pivot catch rotatably mounted to a second side of the carriage plate by the pivot catch shaft;
wherein rotation of the follower bracket causes corresponding rotation of the pivot catch shaft.

8. The system of claim 7, wherein the pivot catch is configured to interact with at least one hook tab extending laterally from at least one side of the hook.

9. The system of claim 8, wherein at least one rotational position of the pivot catch is configured to catch the at least one hook tab and prevent the hook from lowering.

10. The system of claim 8, wherein at least one rotational position of the pivot catch is configured to avoid contact with the at least one hook tab and allow the hook to lower.

11. The system of claim 5, wherein the latch assembly further comprises:
an arm cam surface extending along a lower surface of the latch arm;
a cam roller attached to a free end of an adjustment bracket, wherein said cam roller rolls along the arm cam surface when the latch arm moves upwards and downwards;
a spring end plate adjustably connected to another end of the adjustment bracket, wherein the spring end plate is fixedly attached to an end of the main shaft opposite the hook, such that the main spring is located between the hook and the spring end plate.

12. The system of claim 11, wherein the configuration of the arm cam surface provides a first stop at a first end of the arm cam surface and a second stop at a second end of the arm cam surface, wherein the first stop prevents the cam roller from proceeding along the latch arm as the latch arm moves upward, wherein the second stop prevents the cam roller from proceeding along the latch arm as the latch arm moves downwards.

13. The system of claim 2, wherein the latch pin spring is a torsion spring.

14. The system of claim 2, further comprising a pin support extending from a bottom surface of latch plate to provide support to the latch pin slidably extending therethrough.

15. The system of claim 1, further comprising a spring adjustment attached to one end of the main spring assembly.

16. The system of claim 1, further comprising a release actuator, wherein the release actuator comprises a shaft extending between a handle and a release interface.

17. The system of claim 16, wherein the release interface is configured to interact with a latch release in the latch assembly.

18. The system of claim 1, further comprising a sensor assembly comprising at least one switch trigger, a switch sensor, and at least one indicator signal, wherein the at least one switch trigger is mounted to the latch assembly such that when the latch assembly is in a first position, the at least one switch trigger contacts the switch sensor to actuate the at least one indicator signal.

19. The system of claim 1, further comprising a housing covering a portion of the latch assembly.

20. The system of claim 19, further comprising a brush seal in the housing, wherein at least part of the latch assembly extends through the brush seal.
